(19) United States
(12) Patent Application Publication
(10) Pub. No.: US 2019/0095971 A1
(43) Pub. Date: Mar. 28, 2019

(54) INFORMATION PROCESSOR, GAME SYSTEM, NON-TRANSITORY COMPUTER-READABLE MEDIUM, AND GAME CONTROL METHOD

(71) Applicant: Universal Entertainment Corporation, Tokyo (JP)

(72) Inventors: Masaki OYAMA, Tokyo (JP); Atsushi KUMITA, Tokyo (JP); Toshikazu JINNOUCHI, Tokyo (JP)

(21) Appl. No.: 16/140,726

(22) Filed: Sep. 25, 2018

(30) Foreign Application Priority Data
Sep. 27, 2017 (JP) 2017-187160

(51) Int. Cl. G06Q 30/06; G06Q 20/12

(52) U.S. Cl. CPC G06Q 30/0623; G06Q 20/123; G06Q 30/0643; G06Q 30/0633

(57) ABSTRACT

To improve a user interface related to charged elements, an information processor 1 includes: a display 2 configured to display a screen; a memory 3 configured to store a purchase history of items usable in a game; and a controller 4. When a request for transition to an item-purchase screen 22 showing a list of purchasable items, the information processor 1 displays a list to be displayed in the item-purchase screen 22 which is determined based on paid-amount history for previously purchased items in a purchase history.

### CROSS-REFERENCE TO RELATED APPLICATION

This application claims the benefit of Japanese Patent Application No. 2017-187160, filed on Sep. 27, 2017, which application is incorporated herein by reference in its entirety.

### BACKGROUND OF THE INVENTION

### 1. Field of the Invention

The present invention relates to an information processor, a game system, a non-transitory computer-readable medium, and a game control method.

### 2. Description of Related Art

Traditionally, there has been a structure a plurality of gaming terminals are connected via a server, and cooperation amongst the gaming terminals progresses a game. For example, the specification of U.S. Pat. No. 636,593 discloses a structure including a plurality of gaming terminals and a plurality of upper displays forming a single common effect display screen, wherein whether or not a common game is run is determined when each gaming terminal starts an independent special game, and an effect is performed only in a gaming terminal in which the common game is not run. Competition amongst the gaming terminals to progress the game has been traditionally considered as to be important to enhance players' interest and the value of the gaming machine.

### CITATION LIST

In recent years, games provided on mobile devices such as tablet computers and smartphones are becoming increasingly prevalent. In such games on mobile devices, it is important to have the game progressed by competition amongst users. However, unlike traditional exclusive gaming machines, there are typically items that contribute to improved competitiveness with others in a game and items for exchanging with such items as charged elements. Game provides wish users willing to use such items to continuously play the games.

In games on mobile devices, basic plays are in many cases provided free of charge, and are easily introduced to the mobile devices by downloading and installing the game, which enables users to play many games. However, there are only a limited number of games which are continuously played by users in general for a long period of time. Therefore, it has been difficult to have users select a game provided as a game to be continuously played, and a user-friendly interface related to charged elements to reduce the stress for using the charged elements has been a challenge in order to achieve the above-mentioned wish.

### SUMMARY OF THE INVENTION

In view of the above, it is an object of the present invention to provide an information processor, a game system, a non-transitory computer-readable medium, and a game control method whereby an interface related to a charged element is improved.

### Technical Solution

An aspect of the present invention is an information processor including: a display configured to display a screen; a memory configured to store a purchase history of items usable in a game; and a controller, wherein the controller is programmed to execute: a process of receiving a request for transition to an item-purchase screen showing a list of purchasable items; a process of referring to a memory and retrieving a paid-amount history for one or more items previously purchased from the purchase history, in response to the request; a process of determining a list to be displayed in the item-purchase screen, based on the paid-amount history; and a process of displaying the item-purchase screen in the display state.

With the above structure, a list to be displayed in the item-purchase screen listing the purchasable items is determined based on an amount paid for one or more items previously purchased by the user. Thus, when the user opens the item-purchase screen, a list is displayed based on an amount paid for one or more items previously purchased by the user. Therefore, the interface in the game is improved and the user is able to recognize the amount previously paid and use that information as a reference for a purchase of this time.

The information processor of the present invention may be adapted so that the memory stores therein the plurality of items each associated with a price, and the controller may be programmed to execute a process of determining the list to be displayed so that items of prices according to the paid-amount history are listed.

With the above structure, a list including items based on an amount paid in the previous purchase is determined as the list to be displayed when the user opens the item-purchase screen. The user's paid-amount history is likely to be an affordable amount per purchase for the user, and the above structure enables the user to recognize items of prices approximating the affordable amount, without a need of having the user searching such items. As the result, the user interface in the game is improved.

The information processor of the present invention may be adapted so that the list has an area corresponding to a plurality of screens, and the items are aligned in an order of the prices; and the controller may be programmed to execute a process of determining as a screen display position, a plurality of items, out of the list, which correspond to prices based on the paid-amount history.

With the above structure, the list in the item-purchase screen includes a plurality of screens in which items are aligned in an order of their prices, and when the item-purchase screen is displayed, a screen is set to a position of prices based on the paid-amount history in the alignment. This facilitates the user to easily recognize which screen should be displayed, when the user wishes to purchase an item with a price different from the previous one. As the result, the user interface in the game is improved.

Another aspect of the present invention is a game system including a plurality of information processors, and a server configured to run a game in the plurality of information processors, the system including: a display configured to display a screen on each of the information processors; a memory configured to store a purchase history of items usable in a game; and a controller, wherein the controller is programmed to execute: a process of receiving a request for transition to an item-purchase screen showing a list of purchasable items; a process of referring to a memory and retrieving a paid-amount history for one or more items previously purchased from the purchase history, in response to the request; a process of determining a list to be displayed in the item-purchase screen, based on the paid-amount history; and a process of displaying the item-purchase screen in the display state.

With the above structure, a list to be displayed in the item-purchase screen listing the purchasable items is determined based on an amount paid for one or more items previously purchased by the user. Thus, when the user opens the item-purchase screen, a list is displayed based on an amount paid for one or more items previously purchased by the user. Therefore, the interface in the game is improved and the user is able to recognize the amount previously paid and use that information as a reference for a purchase of this time.

Another aspect of the present invention is a game program which is stored in a non-transitory computer-readable medium, and configured to cause a computer, including a display configured to display a screen and a memory configured to store a purchase history of items usable in a game, to execute a process of receiving a request for transition to an item-purchase screen showing a list of purchasable items; a process of retrieving from a memory a paid-amount history of items previously purchased in the purchase history, in response to the request; a process of determining a list to be displayed in the item-purchase screen, based on the paid-amount history; and a process of displaying the item-purchase screen in the display mode.

With the above structure, a list to be displayed in the item-purchase screen listing the purchasable items is determined based on an amount paid for one or more items previously purchased by the user. Thus, when the user opens the item-purchase screen, a list is displayed based on an amount paid for one or more items previously purchased by the user. Therefore, the interface in the game is improved and the user is able to recognize the amount previously paid and use that information as a reference for a purchase of this time.

Another aspect of the present invention is a game control method implemented by a computer including a display configured to display a screen and a memory configured to store a purchase history of items usable in a game, the method including: wherein the controller is programmed to execute: a process of receiving a request for transition to an item-purchase screen showing a list of purchasable items; a process of referring to a memory and retrieving a paid-amount history for one or more items previously purchased from the purchase history, in response to the request; a process of determining a list to be displayed in the item-purchase screen, based on the paid-amount history; and a process of displaying the item-purchase screen in the display state.

With the above structure, a list to be displayed in the item-purchase screen listing the purchasable items is determined based on an amount paid for one or more items previously purchased by the user. Thus, when the user opens the item-purchase screen, a list is displayed based on an amount paid for one or more items previously purchased by the user. Therefore, the interface in the game is improved and the user is able to recognize the amount previously paid and use that information as a reference for a purchase of this time.

### Advantageous Effects

The present invention improves a user interface related to charged elements.

### BRIEF DESCRIPTION OF THE DRAWINGS

The nature and mode of operation of the present invention will now be more fully described in the following detailed description of the invention taken with the accompanying drawing figures, in which:

FIG. 1 An explanatory diagram showing an operation state of the present invention.

FIG. 2 An explanatory diagram showing a schematic structure of the present invention.

FIG. 3 A block diagram showing an electric structure of an information processor.

FIG. 4 A diagram showing an example display screen on the information processor.

FIG. 5 A diagram showing an example display screen on the information processor.

FIG. 6 A diagram showing an example display screen on the information processor.

FIG. 7 An explanatory diagram of an in-game currency purchase table.

FIG. 8 An explanatory diagram of a usable-item purchase table.

FIG. 9 An explanatory diagram of a purchase history table.

FIG. 10 A diagram showing an example display screen on the information processor.

FIG. 11 A functional block diagram of the information processor.

FIG. 12 A flowchart of an item-purchase screen display process.

FIG. 13 A flowchart of a slot game process.

FIG. 14 A flowchart of a bonus game process.

FIG. 15 An explanatory diagram showing a modification of the in-game currency purchase table.

### DETAILED DESCRIPTION OF THE PREFERRED EMBODIMENT

An information processor of the present invention will be described with reference to figures.

### (Overview)

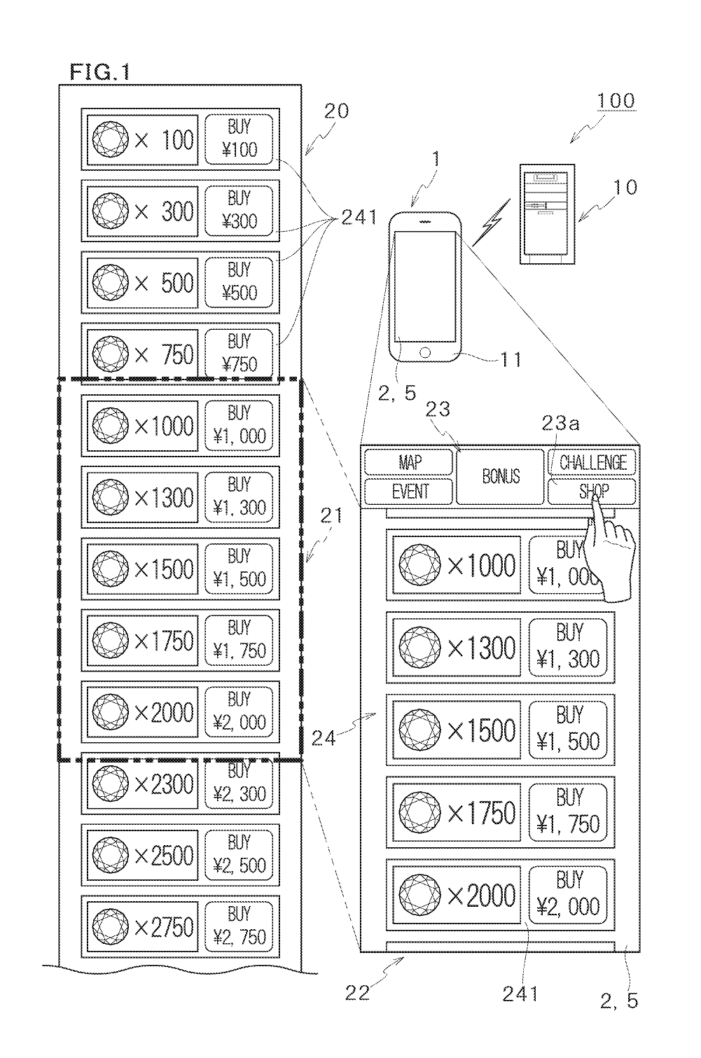

As shown in FIG. 1, an information processor 1 is structured so as to be capable of listing items usable in a game based on a previous purchase history, in an item-purchase screen on which an item is purchased.

The information processor 1 is connected to a server 10 in a data-communicable manner via a communication line, thereby constituting a game system 100 including the information processor 1 and the server 10. It should be noted that the game system 100 is not limited to this, and the system may be constituted only by the information processor 1

The information processor 1 includes a display 2 provided on the front surface of a casing 11, and a touch panel 5 provided throughout the display 2. The information processor 1 may be a mobile device or a desktop device. Examples of mobile information processor 1 include: portable computers, laptop personal computers, tablet personal computers, hand-held personal computers, PDA (Personal Data Assistant), smartphones and the like.

The display 2 is configured to be able to display images. The display method of the display 2 is, for example, liquid crystal, organic electroluminescence, CRT (Cathode Ray Tube), and plasma. The touch panel 5 makes it possible to detect the coordinates of a part touched by a user's finger or the like. The touch panel 5 adopts an already known technology such as electromagnetic induction and electrostatic capacity. The information processor 1 determines an object on the screen touched by the user, or the state of the touching such as swipe and the like based on coordinates detected by the touch panel 5, and makes a response according to the determination result.

It should be noted that, where the display 2 is viewed from the front, a direction towards the lower end is referred to as “downward” or simply as “down”, a direction towards the upper end is referred to as “upward” or simply as “up”, a direction towards the left end is referred to as “leftward” or simply as “left”, and a direction towards the right end is referred to as “rightward” or simply as “right”, in the following description.

Further, in the following description, the expression reading selection or touch input by the user with respect to an object means the information processor 1 determines that an object is selected in relation to the user operation received by the touch panel 5.

Further, in the present embodiment, the touch panel 5 operates as an input device, and accepts a swipe input, a touch input, and the like; however, the present embodiment is not limited to this. For example, a microphone or a camera may be adopted as an input device, and may receive the user's voice or gesture as an instruction input.

As shown in FIG. 1, the display 2 displays an item-purchase screen 22 which shows a list of purchasable charged items. In the present embodiment, the item-purchase screen 22 has a menu area 23 in its upper portion. Further, in the item-purchase screen 22, the area below the menu area 23 is entirely an item display area 24.

The menu area 23 is an area that may be provided in any screen, and not particularly limited to the item-purchase screen 22. In the menu area 23, a shop transition button 23a is arranged, which is an object that allows a touch input to make a transition to the item-purchase screen 22. That is, the information processor 1 receives a request for transition to the item-purchase screen 22, with a touch input on the shop transition button 23a. It should be noted that the transition to the item-purchase screen 22 is not limited to this.

When a screen transition is made to the item-purchase screen 22, list data 20 including all the charged items that could be possibly displayed in the item display area 24 of the item-purchase screen 22 is constructed in the later-described memory 3. In the present embodiment, the list data 20 indicates an arrangement of item areas 241 corresponding to purchasable items in the item-purchase screen 22. Specifically, the list data 20 indicates the entire list of purchasable items to be listed in the item-purchase screen 22, and has an area that corresponds to a plurality of screens of item display areas 24. In the list data 20, all the item areas 241 are arrayed in the vertical direction. In the list data 20, a display area 21 is set, and a range of the list data 20 in the display area 21 is displayed in the item display area 24. That is, items corresponding to the item areas 241 in the display area 21 are displayed in a single screen of the item-purchase screen 22.

In the present embodiment, an initially displayed item-purchase screen 22 is determined, based on a position of the display area 21 set prior to displaying of the item-purchase screen 22. However, the present invention is not limited to this, and for example, the initially displayed item-purchase screen 22 may be determined by changing the order of arranging the item areas 241 in the list data 20. Further, the list data 20 may include only the item areas 241 resulting from filtering. It should be noted that, after the item-purchase screen 22 is displayed, a touch input such as swipe and the like allows a change in the position of the display area 21 set in the list data 20, thereby displaying item areas 241 outside the displayed range.

The display area 21 which determines the initially displayed item-purchase screen 22 is determined prior to displaying of the item-purchase screen 22, based on the item purchase history. The purchase history is stored in the memory 3, and is updated every time the user purchase an item. The purchase history includes paid-amount history indicating an amount paid by the user in the previous purchase. In the present embodiment, the display area 21 which determines the initially displayed item-purchase screen 22 is determined, based on the paid-amount history. In other words, the item areas 241 to be displayed in the item-purchase screen 22 are determined based on the paid-amount history.

As described, a list to be displayed in the item-purchase screen listing the purchasable items is determined based on a previous purchase-amount of the user. Thus, when the user opens the item-purchase screen, a list is displayed based on an amount paid for one or more items previously purchased by the user. Therefore, the interface in the game is improved and the user is able to recognize the amount previously paid and use that information as a reference for a purchase of this time.

It should be noted that the “paid-amount history” is not particularly limited, and may be the highest price of item previously purchased by the user, the lowest price of item previously purchased, or an average of prices of items purchased within a predetermined period. The average of the prices of the purchased items may be calculated irrespective of the number of units, or may be calculated taken into account the number of units. Further, the price of the item may be a price paid for purchasing a single item, or a price paid for a single transaction of purchase (e.g., purchase(s) made within a predetermined period from the start of purchase). Further, the price of item may be a price range set for items. The “Paid-amount history” can be a desirable combination of the above.

Further, it is possible to prepare a plurality of sets of list data. In other words, the item-purchase screen 22 is not limited to one type, and a plurality of types of screens may be provided in such a manner a transition from one screen to another is possible.

In the following description, items usable in the game is referred to as “usable items”. Further, items exchangeable with a usable item is hereinafter referred to as “in-game currency”. All of these are collectively referred to as “items”. Although illustration is omitted, the usable items, the in-game currency are purchasable by a payment program included in the operation system of the information processor 1. For example, when an item purchase request is made in the item-purchase screen 22, the payment program is started from the game, and purchase of an intended item is completed based on a pre-registered credit card number or a deposit made by a pre-paid card, and the like.

Further, in the following description, the prices indicate values of the usable items and the in-game currency, and the unit thereof may be the in-game currency or a generally used currency.

In the present embodiment, the in-game currency is purchasable by using the payment program, and the usable items are purchasable with the in-game currency. That is, when the user wishes to a usable item, he/she first purchases the in-game currency and then exchanges the usable item with an equivalent amount of the in-game currency.

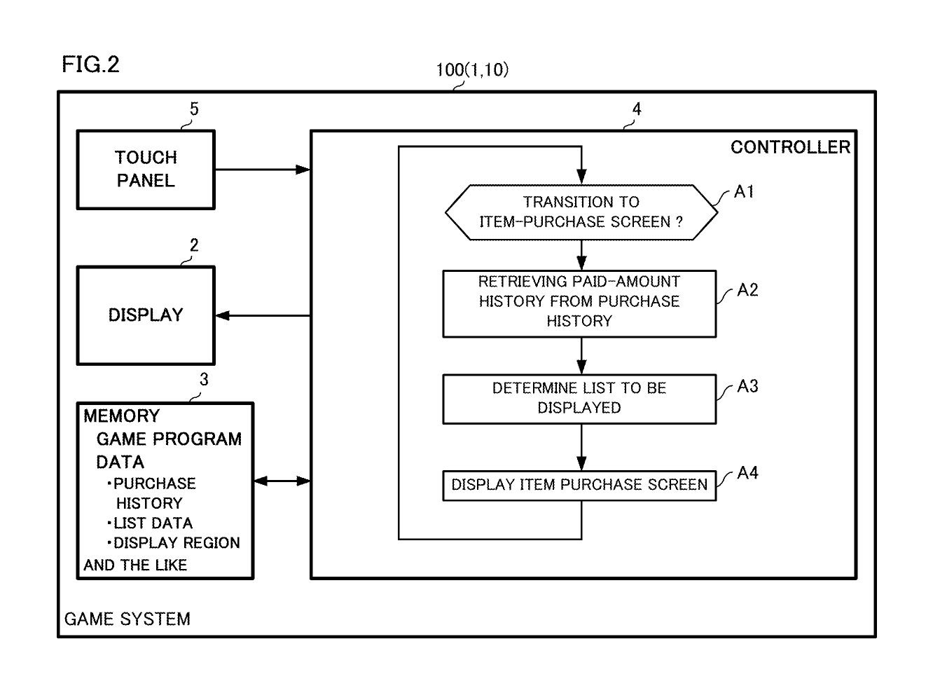

As shown in FIG. 2, the game system 100 includes the information processor 1 and the server 10 each of which is a computer, the display 2, the memory 3, the controller 4, and the touch panel 5.

The display 2 and the touch panel 5 are provided in the information processor 1, and functions as an output device and an input device in the game system 100, respectively.

The memory 3 stores various programs including a game program executed by the controller 4 and various data used in the various programs. The memory 3 is a conceptual storage area in the game system 100, which may be implemented either in the information processor 1 or in the server 10. Alternatively, the function of the memory 3 may be separately implemented in the information processor 1 and the server 10, or the function of the memory 3 may be implemented both in the information processor 1 and the server 10. That is, in the game program executed in the information processor 1, if data stored in the server 10 is necessary, the information processor 1 requests the data to the server 10, and the server 10 responds to such a request of data.

The data and programs to be stored in the memory 3 may be stored in advance at the time of shipping from the plant, or may be stored by downloading them via a communication network from the not-shown server and the like. The communication network may be a bidirectional communication passage such as the Internet and a cable TV, or may be one-way information broadcasting.

Further, the data and programs to be stored in the memory 3 may be stored in a storage medium such as a floppy disc, CD-ROM, DVD-ROM, MO (Magneto-Optical Disc), a flash memory, and may be read out from such a storage medium as needed and installed in the memory 3.

The controller 4 executes various processing according to the game program stored in the memory 3. The controller 4 is a conceptual execution device in the game system 100, which may be implemented either in the information processor 1 or in the server 10. Alternatively, the function of the controller 4 may be separately implemented in the information processor 1 and the server 10, or the function of the controller 4 may be implemented both in the information processor 1 and the server 10.

As described, the game system 100 functions as a single computer including the information processor 1 having the input device (touch panel 3) and an output device (display 2), and the information processor 1 and/or a server 10 serving as the memory 3 and the controller 4.

The controller 4 is programmed to execute the processes as described below. In other words, the game program stored in the memory 3 causes the game system 100 as the computer to execute the processes described below. Specifically, the controller 4 executes: a process (A1) of receiving a request for transition to an item-purchase screen 22 showing a list of purchasable items; a process (A2) of referring to a memory 3 and retrieving a paid-amount history for one or more items previously purchased from the purchase history, in response to the request; a process (A3) of determining a list to be displayed in the item-purchase screen 22, based on the paid-amount history; and a process (A4) of displaying the item-purchase screen 22 in the display state.

As described, a list to be displayed in the item-purchase screen 22 listing the purchasable items is determined based on an amount paid for one or more items previously purchased by the user. Thus, when the user opens the item-purchase screen 22, a list is displayed based on an amount paid for one or more items previously purchased by the user. Therefore, the interface in the game is improved and the user is able to recognize the amount previously paid and use that information as a reference for a purchase of this time.

In addition to the above, as the game system 100 including the program above executes the processes (A1) to (A4), a game control method in which the processes (A1) to (A4) are executed by the game system 100 (computer) is embodied. In other words, the game system 100 includes a plurality of processing units configured to execute the processes (A1) to (A4), respectively. While the descriptions below deal with the game system 100 including the information processor 1 and the server 10, processes and operations of the information processor 1 can be interpreted as those of a program or a game control method. Further, the processes executed by the controller 4 may be executed only in the information processor 1, or only a function as the database may be implemented in the server 10. That is, the processes and operation of the game system 100 may be paraphrased as an invention of the information processor 1.

Further, the memory 3 of the game system 100 stores therein the plurality of items each associated with a price, and the controller 4 may execute the process of determining the list to be displayed so that items of prices according to the paid-amount history are listed.

As described, a list including items based on an amount paid in the previous purchase is determined as the list to be displayed when the user opens the item-purchase screen 22. The user's paid-amount history is likely to be an affordable amount per purchase for the user, and the above structure enables the user to recognize items of prices approximating the affordable amount, without a need of having the user searching such items. As the result, the user interface in the game is improved.

Further, in the game system 100, the list has an area corresponding to a plurality of screens, and the items are aligned in an order of the prices; and the controller 4 may be programmed to execute a process of determining as a screen display position, a plurality of items, out of the list, which correspond to prices based on the paid-amount history.

With the above structure, the list in the item-purchase screen 22 includes a plurality of screens in which items are aligned in an order of their prices, and when the item-purchase screen 22 is displayed, a screen is set to a position of prices based on the paid-amount history in the alignment. This facilitates the user to easily recognize which screen should be displayed, when the user wishes to purchase an item with a price different from the previous one. As the result, the user interface in the game is improved.

(Electrical Structure)

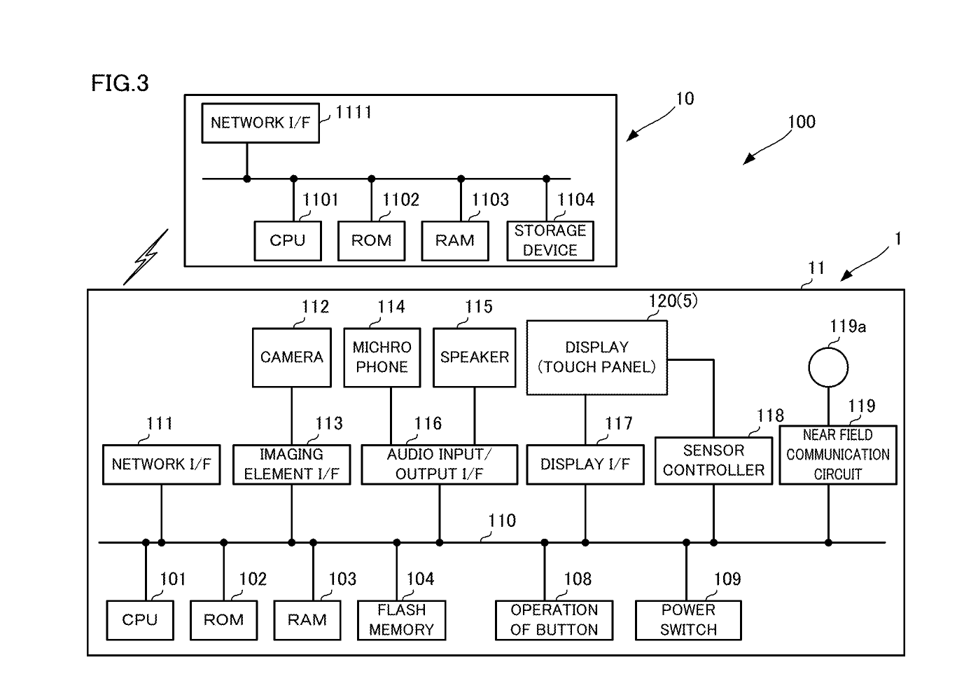

As shown in FIG. 3, the information processor 1 includes, in a housing 11, a CPU 101, a ROM 102, a RAM 103, a flash memory 104, an operation button 108, a power switch 109, a bus line 110, a network OF 111, a camera 112, an imaging element OF 113, a microphone 114, a speaker 115, a sound input/output OF 116, a display OF 117, a sensor controller 118, a near field communication circuit 119, and an antenna 119a of the near field communication circuit 119.

Further, the server 10 is a so-called computer including a CPU 1101, a ROM 1102, a RAM 1103, a storage device 1104 such as a hard disk drive and the like, and a network OF 1111.

The CPU (Central Processing Unit) 101, and the CPU 1101 function as a main structure of the controller 4, and control the entire operation of the game system 100. The ROM (Read Only Memory) 102 and the ROM 1102 store programs used for driving the CPU 101 and CPU 1101, such as an IPL (Initial Program Loader).

The RAM (Random Access Memory) 103 and the RAM 1103 are used as a work area of the CPU 101 and the CPU 1101. The flash memory 104 stores the game program, a program for communication, and plural sets of data such as image data and sound data. The operation button 108 is used for, for example, initial setting of the information processor 1. The power switch 109 is used for turning ON/OFF the power source of the information processor 1.

The storage device 1104 functions as a database, and stores game data of each of the plurality of information processor 1. In response to a request from the game program in the information processor 1, the server 10 returns as needed a response referring to the database in the storage device 1104.

The network I/F (Interface) 111 and the network I/F 1111 are each an interface for data communications using a communications network such as the internet. The camera 112 is a built-in camera image capturing means which captures an image of an object to obtain image data under the control of the CPU 101. The imaging element I/F 113 is a circuit for controlling the camera 112.

The microphone 114 is a built-in sound collection means to which sound is input. The sound input/output I/F 116 is a circuit for processing input and output of a sound signal between the microphone 114 and the speaker 115 under the control of the CPU 101. The display I/F 117 is a circuit for sending image data to the display 2 under the control of the CPU 101. The display 2 is provided on the front surface of the housing 11. The sensor controller 118 is a circuit for receiving an input from the touch panel 5 of the display 2. The near field communication circuit 119 is a communication circuit based on NFC (Near Field Communication) (Registered Trademark). Bluetooth (Registered Trademark), or the like. The bus line 110 is an address bus, a data bus, or the like for electrically connecting the components such as the CPU 101.

In the present embodiment, the functions of the memory 3 and the controller 4 are distributed to the information processor 1 and the server 10 as follows. Specifically, the purchase history including the paid-amount history is stored for each information processor 1 or each user (user account) in the database of the storage device 1104 in the server 10. When the user performs an operation to make a transition to the item-purchase screen 22, the information processor 1 requests the paid-amount history to the server 10 and obtains the purchase history as a response from the server 10. That is, the information processor 1 temporarily stores the purchase history in the RAM 103 and the like. The information processor 1 determines, based on the paid-amount history, a list to be shown in the item-purchase screen 22, and displays the item-purchase screen 22.

It should be noted that the present invention is not limited to this, and the server 10 may determine the list to be shown in the item-purchase screen 22, in response to a request from the information processor 1, based on the paid-amount history. In such a case, the information processor 1 obtains the list to be displayed as a response from the server 10, and displays the item-purchase screen 22 based on the list obtained.

(Display screen)

Next, the following specifically describes a display screen related to item-purchase screen 22 displayed on the information processor 1.

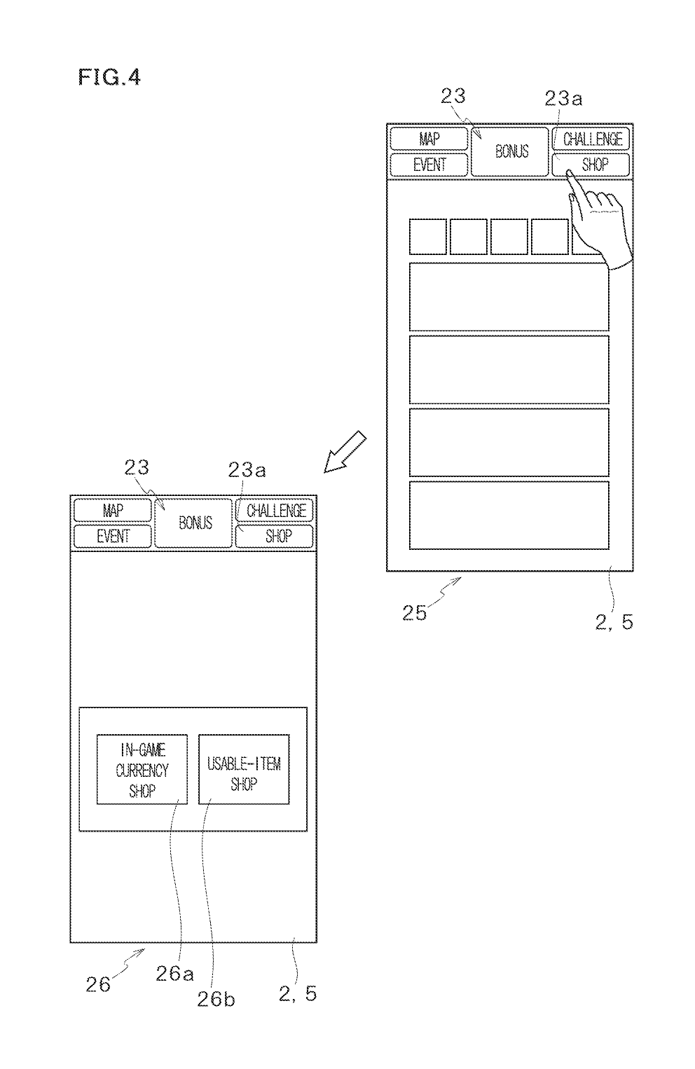

As shown in FIG. 4, a purchasable-item selection screen 26 is displayed upon a touch input to the shop transition button 23a in the menu area 23 of a predetermined screen 25. The purchasable-item selection screen 26 has an in-game currency selection button 26a, and a usable item selection button 26b are displayed. The in-game currency selection button 26a and the usable item selection button 26b are each an object which enables a transition to an item-purchase screen 22a through which the in-game currency is purchasable and to an item-purchase screen 22b through which a usable item is purchasable.

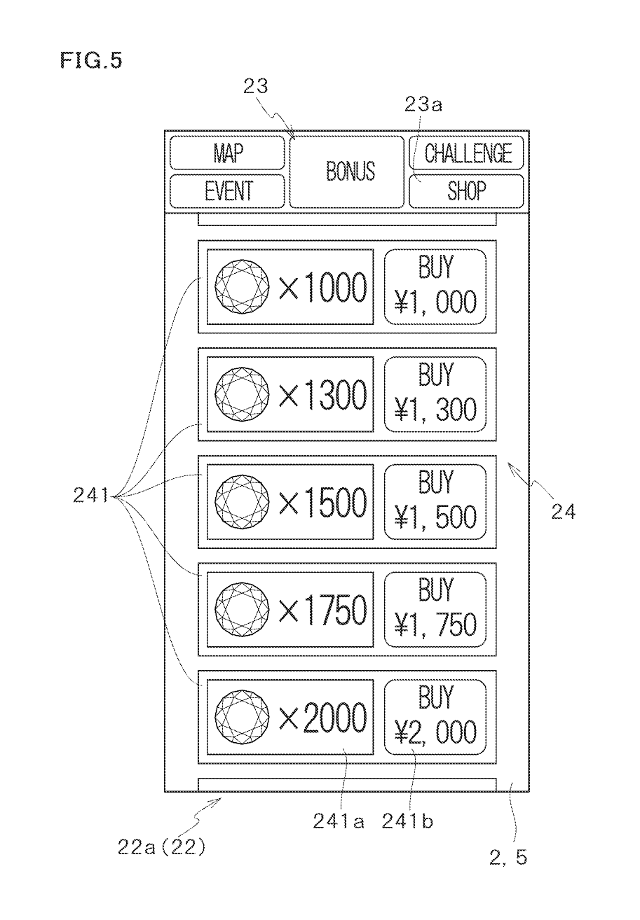

FIG. 5 is a diagram showing an initial state of the item-purchase screen 22a for the in-game currency. As shown in FIG. 5, the item-purchase screen 22a is displayed upon touch input to the in-game currency selection button 26a. As mentioned hereinabove, the item-purchase screen 22a is provided with a menu area 23 in the upper portion, and the item display area 24 throughout the entire portion below the menu area 23.

In the item display area 24, item areas 241 are aligned in the vertical direction as a plurality of items to be purchase targets. In each of the item areas 241, a purchase-target area 241a and a purchase button 241b are displayed. The purchase-target area 241a indicates the specific item to be the purchase target. In cases of the in-game currency, a jewelry-like symbol and the number of such symbols are shown in the purchase-target area 241a, in the present embodiment.

In cases of the in-game currency, the purchase button 241b indicates the price of the items to be the purchase target, with a unit of money. Further, the purchase button 241b is an object selectable for purchasing an item indicated in the corresponding purchase-target area 241a, and is configured to accept a purchase-operation by the user.

In the present embodiment, the item areas 241 to be displayed in the item display area 24, in the initial display state of the item-purchase screen 22a, are item areas 241 of the in-game currency, which costs at least an amount of money the user has previously spent. In the list data 20, the item areas 241 are aligned in the ascending order of the amount of money. Therefore, within a range of the display area 21, the item areas 241 are displayed in the ascending order from the in-game currency previously purchased by the user, in the item display area 24. Specifically, the example of FIG. 5 lists item areas 241 of the in-game currency equivalent to 1000 JPY, 1300 JPY, 1500 JPY, 1750 JPY, and 2000 JPY. This shows that the user has previously purchased the in-game currency equivalent to 1000 JPY.

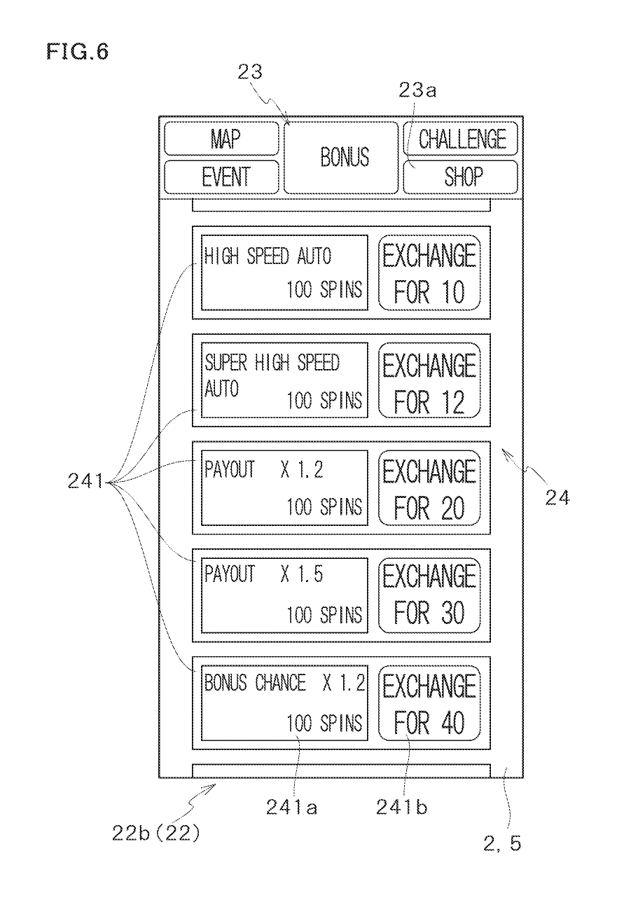

FIG. 6 is a diagram showing an initial state of the item-purchase screen 22b for the usable items. As shown in FIG. 6, the screen is displayed in the same manner as the item-purchase screen 22a for the in-game currency, except for the following points.

That is, the list data 20 used for the item-purchase screen 22b of the usable items is different from that used for the item-purchase screen 22a for the in-game currency. That is, in the list data 20 used for the item-purchase screen 22b of the usable items, the item areas 241 are aligned in the ascending order of the in-game currency associated with the item areas 241.

Further, in each of the item areas 241 in the item-purchase screen 22b for the usable items, the purchase-target area 241a shows a description regarding the effect obtained by using the usable item, as an indication of the specific item to be the purchase target. That is, it shows what advantage is brought about by the usable item, in the game.

Further, in each item area 241 in the item-purchase screen 22b for the usable items, the purchase button 241b shows the price of the targeted usable item in the in-game currency. Further, the purchase button 241b is an object selectable for exchanging an item indicated in the corresponding purchase-target area 241a with the in-game currency, and is configured to accept a purchase-operation by the user.

In the present embodiment, the item areas 241 to be displayed in the item display area 24, in the initial display state of the item-purchase screen 22b, are item areas 241 of usable items that require at least an amount of in-game currency the user has previously spent. In the list data 20, the item areas 241 are aligned in the ascending order of the amount of the in-game currency. Therefore, within a range of the display area 21, the item areas 241 are displayed in the ascending order from the usable item previously purchased by the user, in the item display area 24. Specifically, the example of FIG. 6 lists item areas 241 of usable items costing 10 units, 20 unit value, 12 unit value, 30 unit value, and 40 unit value of the in-game currency. This shows that the user has previously purchased an item costing the in-game currency of 10.

(Data Table)

The following describes data tables stored in the storage device 1104 of the server 10.

(In-Game Currency Purchase Table)

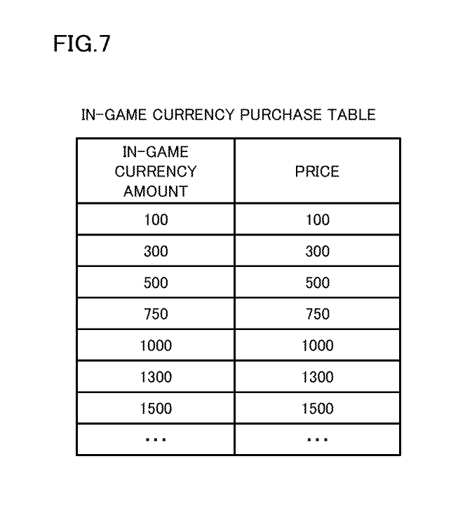

As shown in FIG. 7, the in-game currency purchase table includes an in-game currency value column, and a price column. The in-game currency value column stores purchasable values in the in-game currency. The price column stores the prices for each of the purchasable values in the in-game currency.

For example, when the item-purchase screen 22a for the in-game currency is to be displayed, the information processor 1 inquires server 10 information in the in-game currency purchase table to creates list data 20, and then reflect the information in the item-purchase screen 22a displayed. Thus, when revising the prices of the in-game currency or newly adding a purchasable value of the in-game currency, it only requires changing or adding information to the in-game currency purchase table in the server 10.

(Usable-Item Purchase Table)

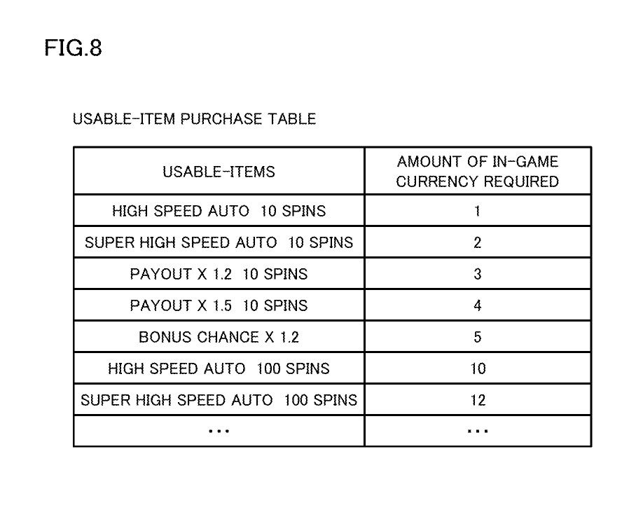

As shown in FIG. 8, the usable-item purchase table includes a usable item column, and a required in-game currency column. The usable item column stores exchangeable usable items. The required in-game currency value column stores a value of the in-game currency required for exchanging the usable item.

For example, when the item-purchase screen 22b for the usable-items is to be displayed, the information processor 1 inquires server 10 information in the usable-item purchase table to creates list data 20, and then reflect the information in the item-purchase screen 22b displayed. Thus, when revising the prices of the usable items or newly adding a purchasable usable item, it only requires changing or adding information to the usable-item purchase table in the server 10.

(Purchase History Table)

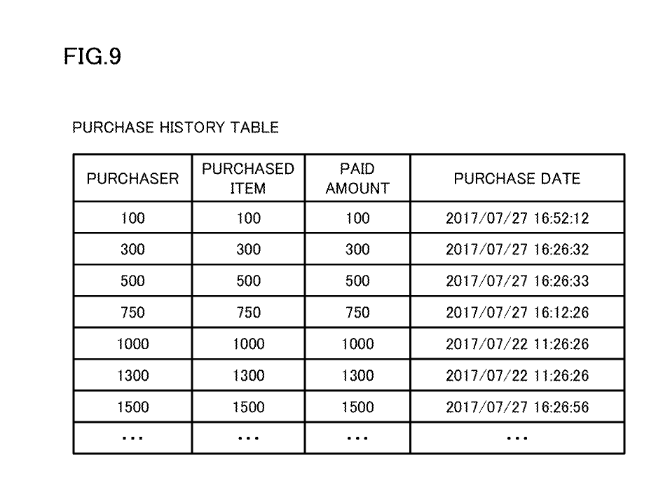

As shown in FIG. 9, the purchase history table includes a purchaser name column, a purchase target column, a price column, and a purchase date column. The purchaser name column stores user IDs as information for identifying the user. The purchase target column stores types of items (in-game currency, usable item) purchased by the user. The price column stores prices (amount of money or the in-game currency spent for the purchase) of items purchased by the user. The purchase date column stores date and time of the purchase by the user.

In the present embodiment, the purchase history table is used for determining the initial display of the item-purchase screen 22. Specifically, when the item-purchase screen 22a for the in-game currency is to be displayed, the information processor 1 requests the paid-amount history to the server 10, using the user ID and the information indicative of the in-game currency as parameters. In response to the request, the server 10 refers to the purchase history table, and searches for the latest purchase history of the in-game currency, from data related to the user ID. Then, the server 10 returns in response to the request, the data (paid-amount history) stored in the price column of the searched data and the information of the above-described in-game currency purchase table. The information processor 1 having received the response from the server 10 creates list data 20 based on the information of the in-game currency purchase table, sets the display area 21 out of the list data 20 based on the paid-amount history, and then display the item-purchase screen 22a.

It should be noted that, although illustration is omitted, the storage device 1104 of the server 10 stores, for each user, the amount of the in-game currency owned, and the number of each type of usable items owned. Every time the user purchase the in-game currency through the item-purchase screen 22, the information processor 1 communicates with the server 10, and adds the amount of in-game currency purchased to the owned amount of the in-game currency. Further, every time the user exchange a usable item with the in-game currency through the item-purchase screen 22, the information processor 1 communicates with the server 10, and subtract the amount of the in-game currency spent from the owned amount of the in-game currency, while incrementing the number of the purchased usable items by a number purchased.

(Slot Game)

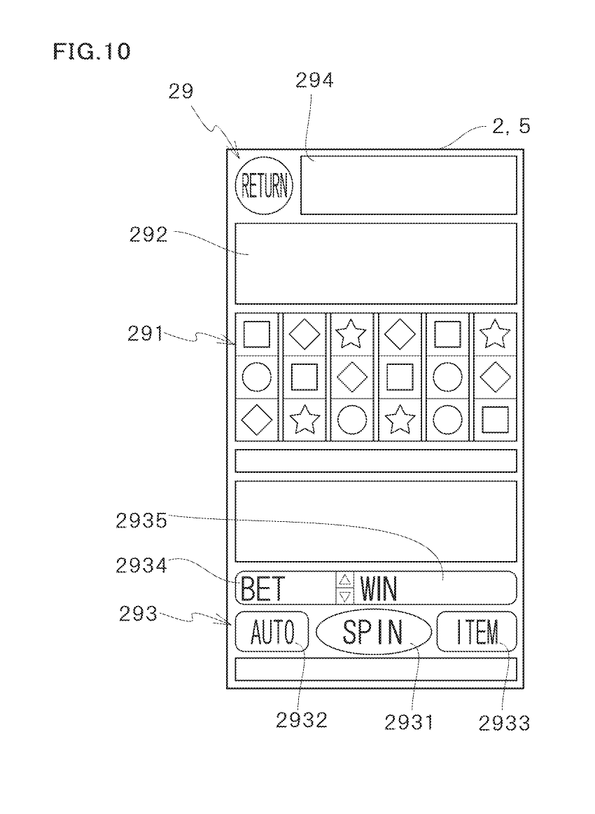

As shown in FIG. 10, the usable items purchased as described above are usable for a slot game which is a game element occurring in the game. It should be noted that the game element is not limited to this, and may be a card game such as poker and baccarat, a roulette game, a pachinko game, a pachinko slot game, and the like.

Specifically, a slot game screen 29 in which the slot game is run includes a game area 291 where symbol display areas 21a are displayed to form plural rows and columns, an effect area 292 where moving images and still images such as game characters are displayed in accordance with the slot game, an operation area 293 which is operated by the user to progress the game, and a game information display area 294 which displays game contents and game information. The operation area 293 includes a spin button 2931, an AUTO button 2932, an ITEM button 2933, a bet button 2934, and a WIN display portion 2935, which are images.

As hereinabove-described, on the entire surface of the display 2, a touch panel 5 which allows the game screen to be viewable from the outside is provided. With this arrangement, for example, the slot game (unit game) is executed once, upon a touch input of the image of the spin button 2931. Furthermore, the slot game is serially executed plural times as the image of the AUTO button 2932 is pressed.

Further, the usable item is selectable by pressing the image of the ITEM button 2933, and the slot game consuming the usable item will enter a state which is advantageous for the user. For example, when a unit game is executed, symbols in a plurality of symbol display areas 21a are variably displayed for a predetermined period, and then stop-displayed. An exchangeable usable item may be one that shortens this period of variable-displaying for a predetermined number of unit games.

Further, for example, a prize is determined out of various types of prizes, based on the arrangement of the symbols rearranged in the plurality of symbol display areas 21a after the symbols are stop-displayed, and an amount of virtual gaming media according to the prize is awarded as a payout. An exchangeable usable item may be one that improves the rate of the payout with respect to the prize. It should be noted that the virtual gaming media are also used as a condition for starting a unit game. Further, for example, An exchangeable usable item may be one that improves a predetermined probability of winning a bonus game.

(Slot Game: Definition)

The base game in the slot game of the present embodiment is a game in which plural symbols are displayed (arranged) by being varied and stopped in the game area 291, and includes a normal game. A state in which a symbol is displayed after being varied and stopped in the game area 291 is termed “rearrangement”. As a bonus game, the free game is executed at least once in the slot game. The slot game may include a process of executing a free game where symbols are rearranged on condition that the payout rate is higher than the payout rate in the normal game and a bonus payout is awarded in accordance with the rearranged symbols.

A gaming value which is awarded when a prize is established as a result of a game result is a coin, paper money, or electrically valuable information corresponding to these. Note that the gaming value in the present invention is not particularly limited. Examples of the gaming value include gaming media such as medals, tokens, cyber money, tickets, and the like. A ticket is not particularly limited, and a barcoded ticket may be adopted for example. Alternatively, the gaming value may be a game point not including valuable information.

The free game is a game which is executable with a smaller amount of gaming values bet than in the normal game. Note that “bet of smaller amounts of gaming values” encompasses a bet of zero gaming value. The “free game” therefore may be a game runnable without a bet of a gaming value, which free game awards an amount of gaming values based on symbols rearranged. In other words, the “free game” may be a game which is started without consumption of a gaming value. To the contrary, the “normal game” is a game runnable on condition that a gaming value is bet, which normal game awards an amount of gaming value based on the symbols rearranged. In other words, the “normal game” is a game which starts with consumption of a gaming value.

The “unit game” is a series of operations from the start of the receiving of a bet to a state in which an award can be established. To put it differently, the unit game includes a single bet time for receiving a bet, a single game time of rearranging stopped symbols, and a single payout time of a payout process of awarding a payout.

A state in which a symbol is displayed after being varied and stopped in the game area 291 is termed “rearrangement”. To put it differently, the term “rearrangement” indicates that the symbols are rearranged after the arrangement of the symbols is dismissed. Arrangement means a state where the symbols can be visibly confirmed by the user.

(Information Processor 1: Example Slot Game: Slot Game)

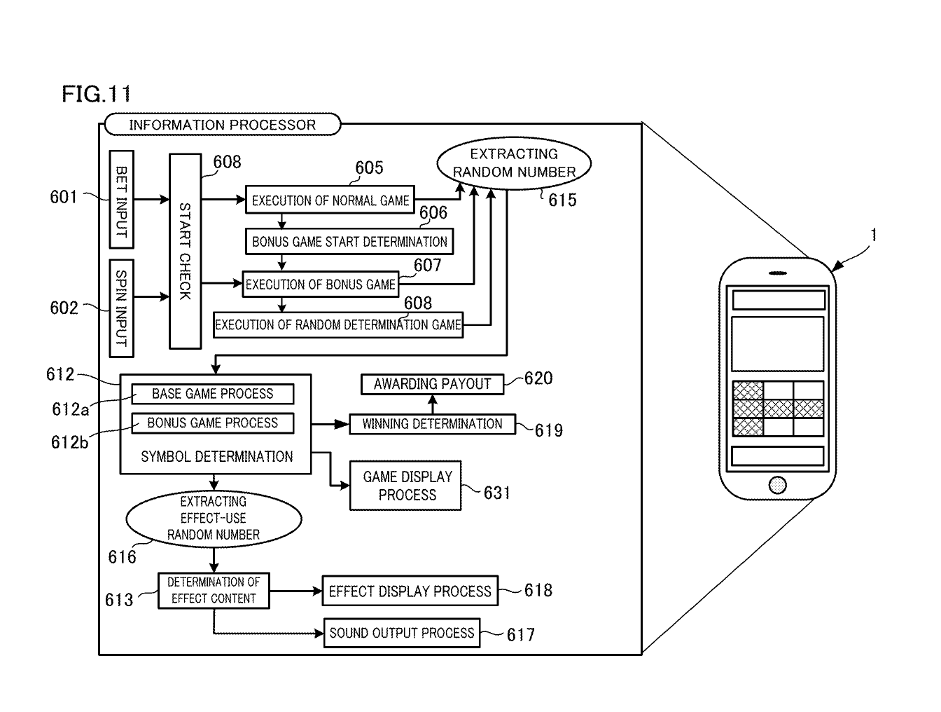

As shown in FIG. 11, the information processor 1 which is the gaming machine running the slot game has the following functions. To be more specific, the information processor 1 includes a BET input unit 601 and a spin input unit 602. The BET input unit 601 and the spin input unit 602 are input devices. The BET input unit 601 has a function of receiving a bet in response to a user operation. The spin input unit 602 has a function of receiving a user operation, i.e., an instruction to start a game.

The information processor 1 includes a start check unit 603, a normal game running unit 605, a bonus game start determining unit 606, a bonus game running unit 607, a random determination game running unit 608, a random number sampling unit 615, a symbol determining unit 612, an effect-use random number sampling unit 616, an effect determining unit 613, a sound output unit 617, an effect display processing unit 618, a winning determining unit 619, a prize awarding unit 620, and a game display processing unit 631.

The normal game running unit 605 has a function of running a normal game which is a base game, on condition that the BET input unit 601 is operated. The bonus game start determining unit 606 determines whether to run a bonus game, based on a combination of the symbols rearranged in the normal game. In other words, the bonus game start determining unit 606 has functions of: determining that the player is entitled to a bonus game when a bonus symbol is rearranged; and activating the bonus game running unit 607 so as to run a bonus game from the subsequent unit game. The random determination game running unit 608 has a function of randomly determining prizes including the bonus game. As this function is executed after the execution by the bonus game running unit 607, the bonus game can be repeatedly run.

The symbol determining unit 612 includes a base game processing unit 612a and a bonus game processing unit 612b. The symbol determining unit 612 including these processing units 612a and 612b has functions of: determining symbols to be rearranged based on a random number given from the random number sampling unit 615; rearranging the determined symbols in the game area 291 of the display 2; outputting rearrangement information of the symbols to the winning determining unit 619; and outputting an effect instruction signal to the effect-use random number sampling unit 616, based on the combination of the rearranged symbols.

The effect-use random number sampling unit 616 has a function of sampling an effect random number when receiving an effect instruction signal from the symbol determining unit 612 and a function of outputting the effect random number to the effect determining unit 613. The effect determining unit 613 has functions of: determining an effect content by using the effect-use random number; outputting image information on the determined effect content to the effect display processing unit 618; and outputting audio and illumination information of the determined effect content to the sound output unit 617.

The winning determining unit 619 has functions of: determining whether a winning is achieved based on a combination of symbols when information rearrangement information of the symbols is given; calculating an amount of payout based on a winning combination formed when it is determined that a winning has been achieved; and outputting, to the prize awarding unit 620, a payout signal which is based on the payout amount. The prize awarding unit 620 has a function of paying out a gaming value to the user.

(Information Processor 1: Example Slot Game: Game Content)

As the slot game, the information processor 1 has three game modes, namely the base game mode, the bonus game mode, and the random determination game mode. The base game mode is a game state during the normal game, whereas the bonus game mode is equivalent to a game state in the free game. The information processor 1 shifts to the bonus game mode when the unit game is run in the base game mode and a bonus trigger condition is satisfied in the base game mode. The trigger of the bonus game is, for example, a condition in which three or more bonus symbols consecutively appear (are rearranged) from the first reel. The trigger of the bonus game may be another condition.

(Information Processor 1: Example Slot Game: Base Game Mode)

The base game mode is specifically described. In the game area 291 displayed on the display 2 shown in FIG. 9, symbols for the slot game are rearrangeable on the video reels with three rows and six columns. In a betting process, a bet amount is selected by the user. The bet amount is, for example, selected from numbers such as 1, 2, 3, 5, and 10 by operating the bet button 2934, or an input of a desirable number may be enabled. The resource generated by accumulating parts of bet amounts is termed jackpot.

Thereafter, in the game area 291, as the symbols are rearranged by varying (scroll-moving) and stopping (scroll-stop) the video reels, whether winning is achieved is determined. Then win determination is performed based on the state of the rearranged symbols. For example, the bonus game trigger is won when the bonus symbols are consecutively rearranged from the first column area (first reel) to the sixth column area (sixth reel). The bonus game trigger is also won when the bonus symbols and a wild symbol which is determined as a substitute for the bonus symbol are consecutively rearranged.

(Information Processor 1: Example Slot Game: Bonus Game Mode)

The base game mode shifts to the bonus game mode when the trigger condition of the bonus game is established, and a free game process is executed, to begin with.

In the free game process, free game reel strips used in the free game are determined, and a predetermined number of times of execution of the free game is set. The reel strips for the free game and the number of times of execution of the free game may be randomly set from a plurality of selections by random number determination.

As the free game is run, win determination is executed. This win determination may be identical with the win determination in the base game. For example, when three or more bonus symbols consecutively appear from the first reel, the retrigger condition of the bonus game (free game) is established.

Thereafter, whether the free game ends is determined. If the free game has not ended (i.e., free game is continued), the free game is run for the remaining number of times.

(Information Processor 1: Operation)

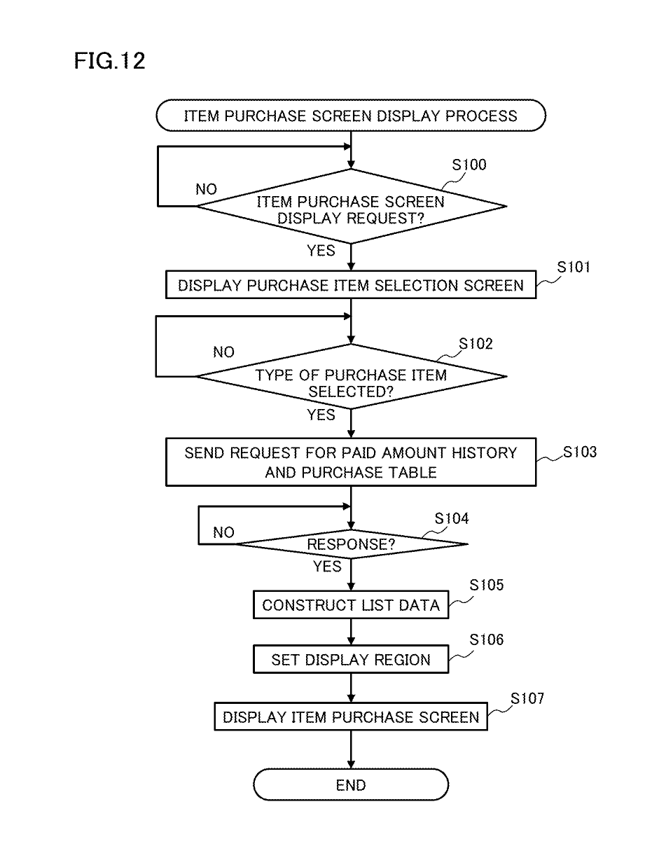

Next, with reference to FIG. 12, the following describes the game program in relation to an item-purchase screen display process executed by the CPU 101 of the information processor 1.

As shown in FIG. 12, the CPU 101 first determines if there is a request for displaying the item-purchase screen 22 (S100). For example, such a request occurs when a touch input is performed to a button in a screen other than the item-purchase screen 22, which causes a transition to the item-purchase screen 22. If the request for displaying the item-purchase screen 22 is not received (S100: NO), the CPU 101 repeats the step S100 and waits for the request.

If a request for displaying the item-purchase screen 22 is received (S100: YES), the CPU 101 displays the purchasable-item selection screen 26 (S101). Then, the CPU 101 determines if any type of the purchasable items; i.e., the in-game currency or the usable item is selected (S102). If neither the in-game currency or the usable item is selected (S102: NO), the CPU 101 repeats the S102 and waits for the selection.

On the other hand, if either the in-game currency or the usable item is selected (S102: YES), the CPU 101 requests to the server 10 information of the paid-amount history and the purchase table (S103). At this time, the CPU 101 adds the user ID and the type of the purchasable items in the request.

Then, the CPU 101 determines if there was a response from the server 10 (S104). If no response is received (S104: NO), the CPU 101 repeats S104 and waits for the response from the server 10. On the other hand, if there was a response from the server 10 (S104: YES), the CPU 101 constructs list data 20 based on the information of the purchase table (information in the in-game currency purchase table, or the usable-item purchase table) (S105). Then, the CPU 101 sets the display area 21 in the list data 20 constructed (S106). That is, the CPU 101 sets the display area 21 in the list data 20, so that the item areas 241 whose prices are at least the latest paid amount retrieved from the server 10 are displayed in the item display area 24.

Then, the CPU 101 displays the item-purchase screen based on the constructed list data 20 and the display area 21 set in the list data 20 (S107), and completes the present routine.

(Information Processor 1: Slot Game Process)

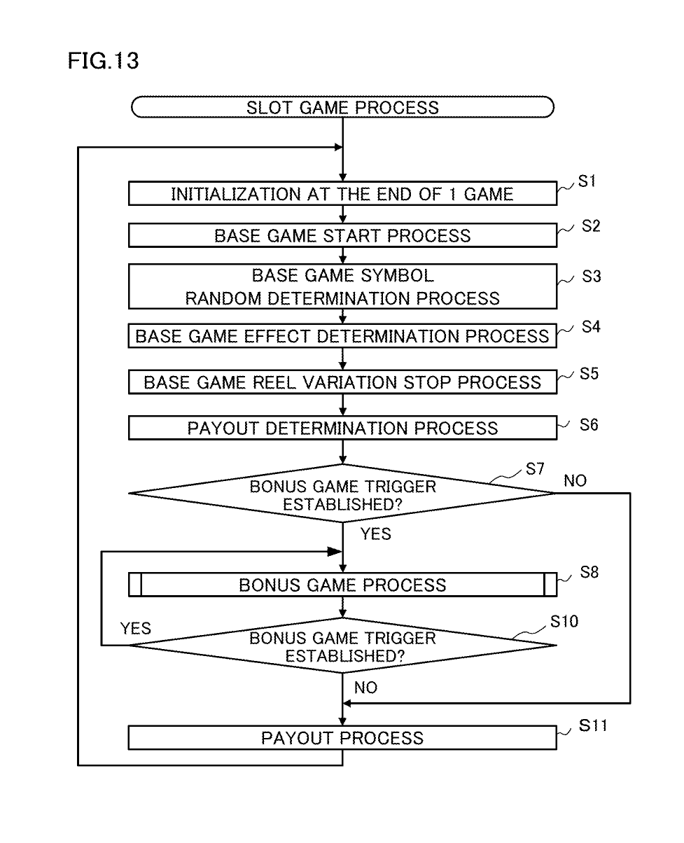

Next, with reference to FIG. 13, the following describes the game program in relation to a slot game process executed by the CPU 101 of the information processor 1.

As shown in FIG. 13, an initializing process at the end of each play of the game is executed (S1). For example, this process clears data in a working area of the RAM 103, which becomes unnecessary at the end of each play of game, e.g., the bet amount and symbols selected by random determination. After a base game start process (S2), a base symbol random determination process is executed (S3). In this process, to-be-stopped symbols are randomly selected and determined based on a random number by using a random determination table.

Then a base game effect determination process is executed (S4). The CPU 101 samples an effect-use random number and randomly determines any of a plurality of predetermined effect contents, and executes the determined effect content at the determined timing. For example, an effect image is displayed in an effect area 292 of the display 2, and sound is output by the speaker 115.

Then a base game reel variation stop process is executed (S5). In this process, the scroll of the symbol columns in the symbol display area 21a starts, and the to-be-stopped symbols determined in the base game symbol random determination process are stopped at predetermined positions.

Then a payout amount determination process is executed (S6). In the base game, a payout amount is determined in accordance with a combination of symbols and based on a payout table, and the determined payout amount is stored in a payout amount storage area of the RAM 103. When the bonus game trigger is established, a payout amount is determined in accordance with a combination of bonus symbols, based on a rule different from the rule in the base game.

Then whether the bonus game trigger has been established is determined (S7). When the bonus game trigger has been established (S7: YES), a bonus game process is executed (S8). Then, when the bonus game trigger has been established (S10: YES), the bonus game process in S8 is executed again.

In the meanwhile, if the bonus game trigger has not been established in S7 or S10 (S7 or S10: NO), a payout process is executed (S11). The CPU 101 adds a value stored in the payout amount storage area to a value stored in a credit amount storage area (credit counter) provided in the RAM 103. Then the steps are executed again from S1.

(Information Processor 1: Bonus Game Process)

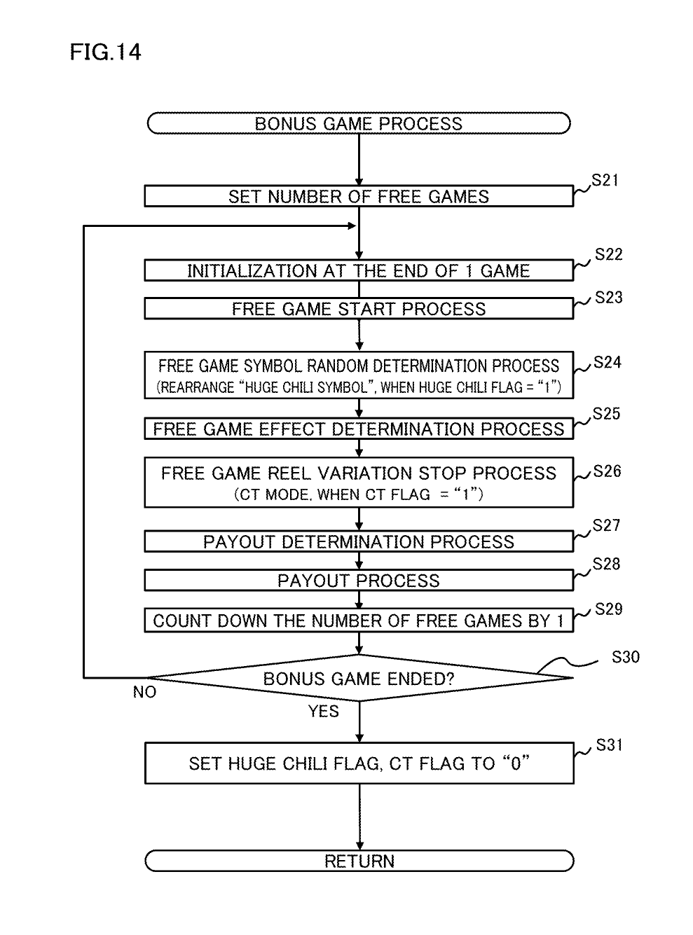

Next, with reference to FIG. 14, the following describes the game program in relation to a bonus game process which is a sub routine of the slot game process executed by the CPU 101 of the information processor 1.

To begin with, the number of times of execution of the free game is set (S21). For example, the number of times of execution of the free game is set at 5. Then an initializing process at the end of each play of the game is executed (S22). For example, this process clears data in a working area of the RAM 103, which becomes unnecessary at the end of each play of game, e.g., the symbols selected by random determination. It is noted that the bet amount in the bonus game is identical with the bet amount in the base game immediately before the shift to the bonus game.

Thereafter, in the same manner as in the base game, a free game start process (S23), a symbol random determination process (S24), and a free game effect determination process (S25) are executed. In the free game, a free game symbol random determination table different from the symbol random determination table in the base game is used. In the free game symbol random determination process, when a Huge Chili flag is set at 1, random determination is executed such that a Huge Chili symbol is to be rearranged.

Thereafter, a free game reel variation stop process (S26) is executed to vary and stop the reels. In this process, the free game is shifted to a CT mode when a CT flag is set at 1. In this mode, the user is allowed to forcibly stop the reels by an operation. Thereafter, a payout amount determination process (S27) and a payout process (S28) are serially executed, and then the number of times of execution of the free game is counted down by 1 (S29). Then whether the bonus game has ended is determined (S30). When the number of times of execution of the free game is not 0 (S30: NO), the steps are executed again from S22 as it is determined that the bonus game has not ended. In the meanwhile, when the number of times of execution of the free game is 0 (S30: YES), it is determined that the bonus game has ended. Then the Huge Chili flag and the CT flag are set at 0 (S31). As such, the flags are maintained at 0 in the bonus game after the base game, and the flags are changed from 1 to 0 in the bonus game after the random determination game. The process is then terminated and the processing routine shown in FIG. 13 is resumed.

(Modification)

In the above embodiment, the item areas 241 determined based on the previous paid amount are displayed in the item display area 24 as the initial display of the item-purchase screen 22; however, the present invention is no limited to this.

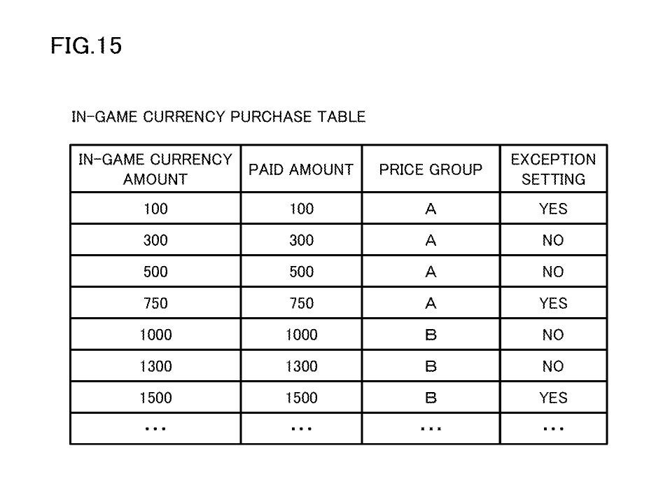

For example, as shown in FIG. 15, price groups based on the value of the in-game currency may be set in the in-game currency purchase table. That is, each item may be associated with a pre-set price range along with the price. At a time of newly displaying the item-purchase screen 22, items belonging to a group of the previous purchase may be displayed in the item display area 24. It should be noted that the same may be applied to the usable-item purchase table, although illustration thereof is omitted.

Further, as shown in FIG. 15, exclusion setting may be set for each value of the in-game currency may be set in the in-game currency purchase table. That is, items having previously purchased and have the exclusion setting may be excluded from the item display area 24, when the item-purchase screen 22 is newly displayed. It should be noted that the same may be applied to the usable-item purchase table, although illustration thereof is omitted.

Further, in the above embodiment, the items to be displayed in the item display area 24 are determined based on the amount paid in the previous purchase; however, the items to be listed in the item display area 24 may be determined based on the past-highest paid amount In this case, after spending of the past-highest paid amount, if the user makes a purchase spending an amount less than the past-highest paid amount for a predetermined number of times, the basis for determining the list to be displayed may be reset. In cases of resetting, the amount used as the basis may be reset to the average value of the purchase history after the spending of the past-highest paid amount. If an amount surpassing the average value is spend in a purchase, the past-highest paid amount for use as the basis of determining the list to be displayed may be updated to that amount surpassing the average value. Further, it is possible to set an offset-value, and the past-highest paid amount for use as the basis of determining the list to be displayed may be updated only when an amount spent in a purchase surpasses the sum of the average value and the offset-value.

(Overview of the Invention)

An information processor 1 including: a display 2 configured to display a screen; a memory 3 configured to store a purchase history of items usable in a game; and a controller 4, wherein the controller 4 is programmed to execute: a process of receiving a request for transition to an item-purchase screen 22 showing a list of purchasable items; a process of referring to a memory 3 and retrieving a paid-amount history for one or more items previously purchased from the purchase history, in response to the request; a process of determining a list to be displayed in the item-purchase screen 22, based on the paid-amount history; and a process of displaying the item-purchase screen 22 in the display state.

With the above structure, a list to be displayed in the item-purchase screen 22 listing the purchasable items is determined based on an amount paid for one or more items previously purchased by the user. Thus, when the user opens the item-purchase screen, a list is displayed based on an amount paid for one or more items previously purchased by the user. Therefore, the interface in the game is improved and the user is able to recognize the amount previously paid and use that information as a reference for a purchase of this time.

Further, the memory 3 of the information processor 1 stores therein the plurality of items each associated with a price, and the controller 4 is programmed to execute the process of determining the list to be displayed so that items of prices according to the paid-amount history are listed.

With the above structure, a list including items based on an amount paid in the previous purchase is determined as the list to be displayed when the user opens the item-purchase screen. The user's paid-amount history is likely to be an affordable amount per purchase for the user, and the above structure enables the user to recognize items of prices approximating the affordable amount, without a need of having the user searching such items. As the result, the user interface in the game is improved.

The information processor 1 of the present invention is adapted so that the list has an area corresponding to a plurality of screens, and the items are aligned in an order of the prices; and the controller 4 is programmed to execute a process of determining as a screen display position, a plurality of items, out of the list, which correspond to prices based on the paid-amount history.

With the above structure, the list in the item-purchase screen 22 includes a plurality of screens in which items are aligned in an order of their prices, and when the item-purchase screen 22 is displayed, a screen is set to a position of prices based on the paid-amount history in the alignment. This facilitates the user to easily recognize which screen should be displayed, when the user wishes to purchase an item with a price different from the previous one. As the result, the user interface in the game is improved.

A game system 100 includes a plurality of information processors 1, and a server 10 configured to run a game in the plurality of information processors 1. The game system 100 includes: displays 2 each configured to display a screen in the information processors; a memory 3 configured to store a purchase history of items usable in a game; and a controller 4, wherein the controller 4 is programmed to execute: a process of receiving a request for transition to an item-purchase screen 22 showing a list of purchasable items; a process of referring to a memory 3 and retrieving a paid-amount history for one or more items previously purchased from the purchase history, in response to the request; a process of determining a list to be displayed in the item-purchase screen 22, based on the paid-amount history; and a process of displaying the item-purchase screen 22 in the display state.

With the above structure, a list to be displayed in the item-purchase screen 22 listing the purchasable items is determined based on an amount paid for one or more items previously purchased by the user. Thus, a list based on the user's previous purchase-amount is displayed, when the user opens the item-purchase screen. Therefore, the interface in the game is improved and the user is able to recognize the previous purchase amount and use that information as a reference for a purchase of this time.

A game program configured to cause a computer, including a display 2 configured to display a screen and a memory 3 configured to store a purchase history of items usable in a game, to execute a process of receiving a request for transition to an item-purchase screen 22 showing a list of purchasable items; a process of retrieving from a memory 3 a paid-amount history of items previously purchased in the purchase history, in response to the request; a process of determining a list to be displayed in the item-purchase screen 22, based on the paid-amount history; and a process of displaying the item-purchase screen 22 in the display mode.

With the above structure, a list to be displayed in the item-purchase screen 22 listing the purchasable items is determined based on an amount paid for one or more items previously purchased by the user. Thus, a list based on the user's previous purchase-amount is displayed, when the user opens the item-purchase screen. Therefore, the interface in the game is improved and the user is able to recognize the previous purchase amount and use that information as a reference for a purchase of this time.

A game control method of the present invention implemented by a computer including a display 2 configured to display a screen and a memory 3 configured to store a purchase history of items usable in a game, includes: a process of receiving a request for transition to an item-purchase screen 22 showing a list of purchasable items; a process of retrieving from a memory 3 a paid-amount history of items previously purchased in the purchase history, in response to the request; a process of determining a list to be displayed in the item-purchase screen 22, based on the paid-amount history; and a process of displaying the item-purchase screen 22 in the display mode.

With the above structure, a list to be displayed in the item-purchase screen 22 listing the purchasable items is determined based on an amount paid for one or more items previously purchased by the user. Thus, a list based on the user's previous purchase-amount is displayed, when the user opens the item-purchase screen. Therefore, the interface in the game is improved and the user is able to recognize the previous purchase amount and use that information as a reference for a purchase of this time.

Embodiments of the present invention thus described above solely serve as specific examples of the present invention, and are not to limit the scope of the present invention. The specific structures and the like are suitably modifiable. Further, the effects described in the embodiments of the present invention described in the above embodiment are no more than examples of preferable effects brought about by the present invention, and the effects of the present invention are not limited to those described hereinabove.

Further, the detailed description above is mainly focused on characteristics of the present invention to for the sake of easier understanding. The present invention is not limited to the above embodiments, and is applicable to diversity of other embodiments. Further, the terms and phraseology used in the present specification are adopted solely to provide specific illustration of the present invention, and in no case should the scope of the present invention be limited by such terms and phraseology. Further, it will be obvious for those skilled in the art that the other structures, systems, methods or the like are possible, within the spirit of the present invention described in this specification. The description of claims therefore shall encompass structures equivalent to the present invention, unless otherwise such structures are regarded as to depart from the spirit and scope of the present invention. Further, the abstract is provided to allow, through a simple investigation, quick analysis of the technical features and essences of the present invention by an intellectual property office, a general public institution, or one skilled in the art who is not fully familiarized with patent and legal or professional terminology. It is therefore not an intention of the abstract to limit the scope of the present invention which shall be construed on the basis of the description of the claims. To fully understand the object and effects of the present invention, it is strongly encouraged to sufficiently refer to disclosures of documents already made available.

The detailed description of the present invention provided hereinabove includes a process executed on a computer. The above descriptions and expressions are provided to allow the one skilled in the art to most efficiently understand the present invention. A process performed in or by respective steps yielding one result or blocks with a predetermined processing function described in the present specification shall be understood as a process with no self-contradiction. Further, the electrical or magnetic signal is transmitted/received and written in the respective steps or blocks. It should be noted that such a signal is expressed in the form of bit, value, symbol, text, terms, number, or the like solely for the sake of convenience. Although the present specification occasionally personifies the processes carried out in the steps or blocks, these processes are essentially executed by various devices. Further, the other structures necessary for the steps or blocks are obvious from the above descriptions.

### REFERENCE SIGNS LIST

1. information processor; 2. display; 3. memory; 4. controller; 5. touch panel

What is claimed is:

1. An information processor comprising: a display configured to display a screen; a memory configured to store a purchase history of items usable in a game; and a controller, wherein the controller is programmed to execute: a process of receiving a request for transition to an item-purchase screen showing a list of purchasable items; a process of referring to a memory and retrieving a paid-amount history for one or more items previously purchased from the purchase history, in response to the request; a process of determining a list to be displayed in the item-purchase screen, based on the paid-amount history; and a process of displaying the item-purchase screen in the display state.

2. The information processor according to claim 1, wherein the memory stores therein the plurality of items each associated with a price, and the controller is programmed to execute the process of determining the list to be displayed so that items of prices according to the paid-amount history are listed.

3. The information processor according to claim 2, wherein the list has an area corresponding to a plurality of screens, and the items are aligned in an order of the prices; and the controller may be programmed to execute a process of determining as a screen display position, a plurality of items, out of the list, which correspond to prices based on the paid-amount history.

4. A game system comprising: a plurality of information processors, and a server configured to run a game in the plurality of information processors, the system comprising: a display configured to display a screen in the corresponding one of the information processors; a memory configured to store a purchase history of items usable in a game; and a controller, wherein the controller is programmed to execute: a process of receiving a request for transition to an item-purchase screen showing a list of purchasable items; a process of referring to a memory and retrieving a paid-amount history for one or more items previously purchased from the purchase history, in response to the request; a process of determining a list to be displayed in the item-purchase screen, based on the paid-amount history; and a process of displaying the item-purchase screen in the display state.

5. A game program, which is stored in a non-transitory computer-readable medium, configured to cause a computer, including a display configured to display a screen and a memory configured to store a purchase history of items usable in a game, to execute a process of receiving a request for transition to an item-purchase screen showing a list of purchasable items; a process of retrieving from a memory a paid-amount history of items previously purchased in the purchase history, in response to the request; a process of determining a list to be displayed in the item-purchase screen, based on the paid-amount history; and a process of displaying the item-purchase screen in the display mode.

6. A game control method implemented by a computer including a display configured to display a screen and a memory configured to store a purchase history of items usable in a game, the method comprising: a step of receiving a request for transition to an item-purchase screen showing a list of purchasable items; a step of referring to a memory and retrieving a paid-amount history for one or more items previously purchased from the purchase history, in response to the request; a step of determining a list to be displayed in the item-purchase screen, based on the paid-amount history; and a step of displaying the item-purchase screen in the display state.
